(19) United States
(12) Patent Application Publication
(10) Pub. No.: US 2026/0264125 A1
(43) Pub. Date: Sep. 10, 2026

(54) SYSTEM AND METHOD FOR EFFICIENT ORGANIC WASTE PROCESSING

(71) Applicant: White Horse Bio-Systems LLC, Dallas, TX (US)

(72) Inventors: Neysa Osborne, Dallas, TX (US); Beth Johnson, Sasakwa, OK (US); Deborah Sherouse, Sasakwa, OK (US)

(73) Assignee: White Horse Bio-Systems LLC, Dallas, TX (US)

(21) Appl. No.: 19/558,059

(22) Filed: Mar. 5, 2026

Related U.S. Application Data
(60) Provisional application No. 63/767,276, filed on Mar. 5, 2025.

(51) Int. Cl. B09B 3/65; B09B 3/30; B09B 3/40

(52) U.S. Cl. CPC B09B 3/65; B09B 3/30; B09B 3/40

(57) ABSTRACT

A system and method for efficient organic waste processing utilizes an integrated network of a central processing facility and multiple satellite facilities. Organic waste is collected and transported via a specialized transportation system to storage and preprocessing units. The waste is preserved in cold storage, reduced to uniform particle sizes through coarse and fine grinding, and thermally treated in a batch cooker to deactivate pathogens and generate a sterilized effluent. The resulting slurry is homogenized in a mixer and processed through a mesophilic digester to produce methane gas and a digested slurry. The methane is purified in a gas cleaner and converted into electricity via a generator for supply to a power grid. The digested slurry is separated by a centrifuge to yield phosphorus, fertilizer liquid, and solids, with the solids undergoing further treatment in a thermophilic system to maximize gas yield and reduce final waste volume.

### PRIORITY

This application claims priority to U.S. Provisional Patent Application Ser. No. 63/767,276 entitled SYSTEM AND METHOD FOR EFFICIENT ORGANIC WASTE PROCESSING filed on Mar. 5, 2025, the entirety of which is incorporated by reference herein.

### BACKGROUND

The management of agricultural waste has long posed significant challenges, particularly in large-scale livestock farming. Traditional methods, such as direct application to land or storage in lagoons, result in environmental hazards, including groundwater contamination, methane emissions, and pathogen spread. These issues contribute to climate change, public health concerns, and regulatory pressures on agricultural operations.

Anaerobic digestion (AD) systems have emerged as a promising solution, offering a sustainable approach to waste management. These systems convert organic waste, such as manure and food byproducts, into biogas—a renewable energy source rich in methane—and valuable byproducts like nutrient-rich fertilizers. However, existing AD technologies often require substantial upfront costs, have limited adaptability to diverse feedstocks, and lack efficiency in processing pathogens and greenhouse gases.

There is an increasing demand for scalable, efficient waste-to-energy solutions that integrate seamlessly into agricultural operations while addressing both environmental and economic concerns. Innovations in thermophilic anaerobic digestion and modular designs provide opportunities to enhance waste conversion efficiency, expand usability across various agricultural settings, and yield higher-value byproducts.

### SUMMARY

The illustrative embodiments provide a method and system for processing organic waste through an integrated network comprising a central processing facility and a plurality of satellite facilities. Organic waste is transported via a system of pipelines, vacuum trucks, or conveyors to a facility where it is preserved in cold storage units at controlled temperatures, specifically between 0°C to 5°C. The waste is reduced to uniform particle sizes using a combination of coarse and fine grinders. A batch cooker then thermally treats the ground waste to deactivate pathogens, resulting in a sterilized effluent slurry. This slurry is homogenized in a mixer and introduced into a mesophilic digester operating between 30°C to 40°C, utilizing optimized microbial communities, such as Methanosaeta and Methanobacterium species to produce methane. The resulting methane is purified in a gas cleaner and converted into electricity by a generator for supply to a power grid, capable of offsetting at least 80% of the facility's energy requirements. The digested slurry is separated by a centrifuge to yield phosphorus with at least 95% purity, fertilizer liquid, and solids. These solids undergo further processing in a thermophilic system operating at 50°C to 60°C, which reduces volatile solids by at least 70% and total waste volume by at least 30%. The system is further optimized through a heat recovery system that recycles heat from the generator to maintain optimal digester temperatures.

To enhance scalability and efficiency, the satellite locations function as decentralized units that preprocess waste before transferring it to the central location for final processing and fertilizer refinement. These modular satellite units can include cold storage, grinders, and effluent tanks, and are capable of transmitting operational data to the central plant via a smart control system for real-time monitoring. Additionally, mobile thermophilic units may be deployed to satellite locations based on demand, reducing the need for permanent infrastructure at every site. Beyond energy and nutrient recovery, the illustrative embodiments are designed to produce high-value bio-oil from organic solids via a bioreactor for use as asphalt binders or industrial coatings. By integrating these multi-stage digestion and resource recovery processes, the system achieves a total waste volume reduction of at least 90% while providing a sustainable, circular economy solution for agricultural waste.

Illustrative embodiments relate to a system and method for the efficient processing of organic waste, particularly agricultural and livestock waste such as manure, animal carcasses, food byproducts, and crop residues, into renewable energy, high-value fertilizers, and other commercially useful bioproducts while achieving substantial volume reduction and environmental compliance. The embodiments employ an integrated network comprising a central processing facility located near high-density waste sources and a plurality of modular satellite facilities that enable decentralized preprocessing and collection. Organic waste is transported to the facilities via pipelines, vacuum trucks, conveyors, rail, or drones and is first preserved in cold-storage units maintained between 0°C and 5°C to inhibit premature decomposition. The preserved waste is then reduced to uniform particle sizes through sequential coarse and fine grinding, followed by thermal treatment in a batch cooker that deactivates pathogens and produces a sterilized effluent slurry. This slurry is homogenized in a mixer and introduced into a mesophilic anaerobic digester operating at 30°C to 40°C with optimized microbial communities, generating methane-rich biogas that is purified, combusted in a generator to produce electricity (offsetting at least 80% of facility energy requirements), and supplied to the power grid. The resulting digested slurry is separated by a high-speed centrifuge to recover phosphorus at ≥95% purity, a nutrient-rich fertilizer liquid, and solid fractions; the solids are subsequently processed in a thermophilic system operating at 50°C to 60°C to achieve at least 70% volatile-solids reduction and further overall waste-volume reduction of at least 90%. Heat recovered from the generator is recycled to maintain optimal digester temperatures, while the modular, plug-and-play design of satellite units, including optional mobile thermophilic units and smart IoT monitoring, allows scalable deployment across farms of varying sizes. Additional embodiments incorporate a bioreactor for converting residual solids into bio-oil suitable for asphalt binders or industrial coatings, thereby creating a closed-loop, circular-economy solution that eliminates traditional lagoon storage hazards, reduces greenhouse-gas emissions, recovers scarce nutrients, and supports rural economic development without requiring large upfront capital at every site.

### BRIEF DESCRIPTION OF THE DRAWINGS

Illustrative embodiments of the present invention are described in detail below with reference to the attached drawing figures, which are incorporated by reference herein and wherein:

FIG. 1 is a block diagram of a system for anaerobic digestion and bioproduct recovery in accordance with an illustrative embodiment;

FIG. 2 is a pictorial representation of a system for waste management and resource recovery in accordance with an illustrative embodiment;

FIG. 3 is a pictorial representation of a system for processing organic waste and converting the waste into renewable energy and valuable byproducts in accordance with an illustrative embodiment;

FIG. 4 is a pictorial representation of an anaerobic digester system in accordance with an illustrative embodiment;

FIG. 5 is a pictorial representation of an anaerobic digestion system in accordance with an illustrative embodiment;

FIG. 6 is a pictorial representation of an anaerobic digestion system in accordance with an illustrative embodiment;

FIG. 7 is a pictorial representation of a psychrophilic anaerobic digestion system in accordance with an illustrative embodiment;

FIG. 8 is a pictorial representation of a flowchart for a waste management and bioproduct recovery system;

FIG. 9 is a flowchart of a process for processing organic wastes in accordance with an illustrative embodiment;

FIG. 10 is a flowchart of a process for transporting and preprocessing waste in accordance with an illustrative embodiment;

FIG. 11 is a flowchart of a process for anaerobic digestion and energy generation in accordance with an illustrative embodiment.

FIG. 12 is a flowchart of a process for resource recovery and byproduct processing in accordance with an illustrative embodiment; and

FIG. 13 is a flowchart of a process for system operation and optimization in accordance with an illustrative embodiment.

### DETAILED DESCRIPTION OF THE DRAWINGS

The illustrative embodiments provide a system, method, platform and facilities to process organic waste. The illustrative embodiments are utilized to stop or minimize environmental pollution. A central plant may be established proximate near organic waste generators, such as housed animal farms, animal processing facilities, crop processing facilities, restaurants, or so forth. In one embodiment, housed animal farms are able to lower costs and bring them up to sanitary standards. Green energy is produced to meet and exceed green energy goals, quotas, regulations, and industry standards. Clean and balanced fertilizer may be produced for farmers to rehydrate the land, enhance sustainability practices, and increase yields. Methane and bio-oil may be produced for various uses (e.g., roads) and polluting vapors and noxious emissions are reduced. Phosphorous is recovered to supplement global supplies and preserve depletion of remaining stores. The illustrative embodiments provide employment opportunities for rural areas to increasing opportunities for entrepreneurship, business, and jobs.

The illustrative embodiments provide a modular system designed to support the diverse needs of local farms. The modular nature allows the system to be deployed in scalable units, enabling farms of varying sizes to adopt components tailored to their operational requirements. By breaking down complex waste management and energy recovery processes into discrete, standalone modules, the system ensures that even small and medium-sized agricultural operations may benefit from advanced technologies without the financial burden of investing in large-scale infrastructure.

Each module within the system is designed to perform specific functions independently, yet they may seamlessly integrate when combined. For example, a farm may initially install a basic module including a cold storage unit, grinders, and a mesophilic digester to handle daily waste processing and energy generation. Over time, as operational needs grow, additional modules such as a thermophilic digester, centrifuge for nutrient recovery, or bio-oil extraction units may be added. This plug-and-play capability allows farms and a central processing facility to incrementally scale their systems, aligning expansion with available resources and changing market demands.

The modular design also supports a decentralized approach to waste management, which is particularly advantageous for local farms. By enabling on-site processing of organic waste, transportation costs and associated carbon emissions are significantly reduced. Farms may convert waste into renewable energy to power their operations, with surplus electricity fed into local grids, creating potential revenue streams. Additionally, the system’s modular nutrient recovery components provide farms with access to high-quality fertilizers tailored to their specific crop needs, reducing dependence on chemical fertilizers and promoting sustainable agricultural practices.

Another critical aspect of the modular design is the inclusion of mobile processing units, such as portable thermophilic digesters. These units may be shared among multiple farms within a cooperative network, allowing high-temperature digestion of organic solids without requiring each farm to invest in dedicated infrastructure. This shared-resource model promotes community collaboration, optimizes resource utilization, and supports circular economy principles by ensuring that all organic waste is effectively processed and repurposed.

The system’s modular embodiments also incorporate advanced digital technologies for real-time monitoring and control. IoT-enabled sensors and smart control systems track key performance metrics such as digestion rates, biogas yield, and nutrient composition. This data-driven approach ensures optimal performance of each module, allows for predictive maintenance, and facilitates process adjustments tailored to specific operational goals. Remote access capabilities enable centralized oversight of multiple modular installations, supporting the coordinated management of decentralized systems across different farm locations.

In one embodiment, all or portions of the subsystems may be integrated into semi-trailers or shipping containers that may be moved from location to location, expanded, and interconnected to maximize processing of the organic waste. For example, standard 20 foot, 40 foot, or other default sized shipping containers may be utilized. Drone systems may also be utilized to move organic waste and materials that are processed or being processed.

In line with the invention’s sustainability goals, the modular design enhances adaptability and resilience in agricultural operations. The ability to scale, modify, or relocate modules in response to environmental, regulatory, or market changes ensures that local farms remain competitive and compliant with evolving standards. This flexibility not only lowers entry barriers for adopting sustainable technologies but also empowers local farmers to become self-sufficient energy producers and stewards of sustainable land management practices.

Ultimately, the modular nature of the described embodiments addresses critical challenges in agricultural waste management, energy generation, and nutrient recovery. By offering scalable, adaptable, and community-oriented solutions, the system supports the transition of local farms toward sustainable, circular, and energy-resilient agricultural practices, fulfilling the core objectives of the invention.

The illustrative embodiments introduce a novel anaerobic digestion system that optimizes waste conversion rates, reduces emissions, and delivers multiple commercially valuable outputs, including bio-oil for industrial applications and pathogen-free fertilizers. By addressing the limitations of current technologies, this invention not only mitigates environmental impacts but also empowers agricultural stakeholders with economically viable and sustainable waste management options.

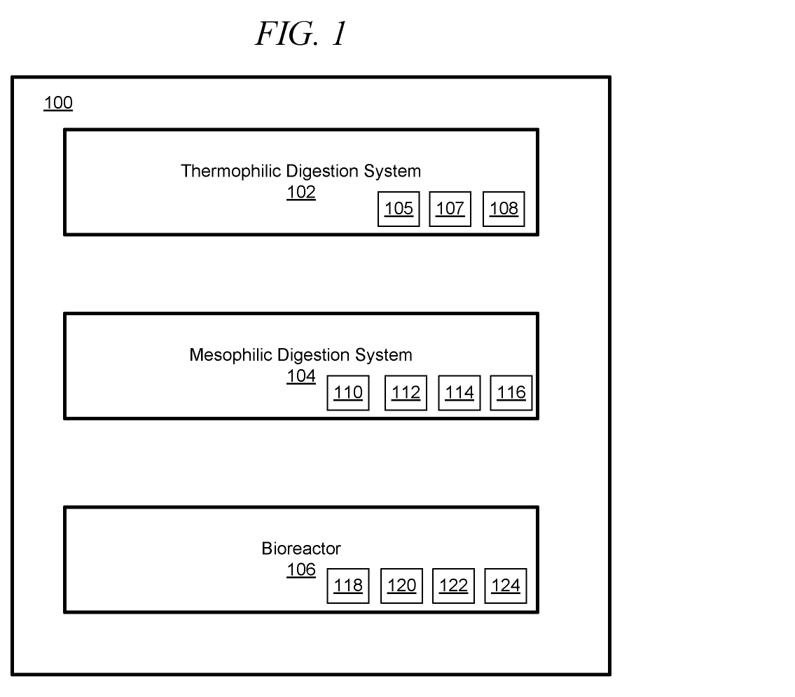

FIG. 1 is a block diagram of a system 100 for anaerobic digestion and bioproduct recovery in accordance with an illustrative embodiment. The system 100 is configured for integrated anaerobic digestion and bioproduct recovery. The system 100 represents an integrated waste management and energy recovery system designed for the efficient conversion of organic waste into renewable energy and valuable byproducts. The system 100 operates through the coordinated functionality of at least three core components including a thermophilic digestion system 102, a mesophilic digestion system 104, and a bioreactor 106.

Referring now to FIG. 1, there is illustrated block diagram of a system 100 for waste management and bioproduct recovery. The system 100 is configured to process organic waste, including manure (e.g., swine, cattle, poultry, etc.), feed/food waste, agricultural byproducts, and animal carcasses, to generate renewable energy and valuable byproducts while minimizing environmental impact. The system 100 may include three primary subsystems including the thermophilic digestion system 102, the mesophilic digestion system 104, and the bioreactor 106.

The thermophilic digestion system 102 is configured to process organic waste at elevated temperatures, typically in the range of approximately 50°C to 60°C. The elevated temperature facilitates rapid decomposition of organic matter by thermophilic microorganisms, resulting in accelerated biogas production and the elimination of pathogens. Waste materials requiring intensive decomposition or high pathogen reduction, such as animal carcasses and pathogen-laden manure, are directed to thermophilic digestion system 102.

The thermophilic digestion system 102 may also include preprocessing units 105 configured to crush, grind, homogenize, and pasteurize incoming waste streams to ensure uniform feedstock and pathogen destruction. Different sizes of crushers, grinders, and mixers may be included as part of the preprocessing units 105.

The thermophilic digestion system 102 may also include anaerobic digesters 107 designed to maintain thermophilic conditions, thereby promoting microbial activity for efficient biogas generation. The anaerobic digesters 107 are equipped with temperature control systems, mixers, and biogas collection domes. For example, methane may be generated by the anaerobic digesters 107.

The thermophilic digestion system 102 may also include a biogas purification module 108 for cleaning and conditioning the generated biogas, allowing its use in combined heat and power (CHP) systems or direct injection into natural gas pipelines. The digestate produced by thermophilic digestion system 102, which includes liquid and solid fractions, is further processed in subsequent subsystems.

The mesophilic digestion system 104 operates at moderate temperatures, typically in the range of approximately 30°C to 40°C, to process continuous feedstocks, such as liquid manure and wastewater effluent. Mesophilic digestion is characterized by its long retention time, stable operation, and high methane yield, making it suitable for handling large volumes of relatively uniform waste streams.

The mesophilic digestion system 104 may include a feedstock transfer pumps 110 and holding tanks 112 for continuous feeding of manure and wastewater into digestion chambers 114. The digestions chambers 114 perform anaerobic digestion to optimize methane production while maintaining mesophilic conditions. The digestion chambers 114 may include multi-stage separation systems to enhance process efficiency. The mesophilic digestion system 104 may include gas storage and recovery units 116 to collect and store biogas for downstream applications. The liquid digestate produced by the mesophilic digestion system 104 may be utilized as a nutrient-rich fertilizer or directed to the bioreactor 106 for further processing.

The bioreactor 106 is configured to process solid fractions separated from the digestate streams of thermophilic digestion system 102 and mesophilic digestion system 104. The bioreactor 106 is designed to convert organic solids into high-value bioproducts, including bio-oil, through a combination of thermal and chemical processes. The bioreactor 106 may include solid fraction feed mechanisms 118 to transport separated solids into the bioreactor 106. The solids may be blended with water or other additives to optimize the conversion process. The bioreactor 106 may include thermal reaction chambers 120 operating at elevated temperatures to decompose organic materials into bio-oil and residual byproducts. The bioreactor 106 may be equipped with heat recovery systems 122 to improve energy efficiency.

The bioreactor 106 may include bio-oil collection and purification units 124 for refining the bio-oil to meet industrial specifications. The bio-oil may be used as an asphalt binder, a feedstock for specialty coatings, or other renewable material applications. The residual solids from bioreactor 106 may be utilized as a soil amendment or combined with other outputs to create additional marketable products.

The system 100 operates in an integrated manner to maximize the efficiency of waste conversion and byproduct recovery. Organic waste streams are preprocessed to ensure uniformity before being routed to the thermophilic digestion system 102 or the mesophilic digestion system 104, depending on the specific characteristics of the waste. The biogas generated by both digestion systems is collected, cleaned, and either utilized for electricity generation, heating applications, or direct sale to energy markets.

The liquid fractions of the digestate are treated and processed into nutrient-rich fertilizers, while the solid fractions are directed to bioreactor 106 for conversion into bio-oil. Heat generated during biogas combustion in combined heat and power systems is recycled to maintain the operating temperatures of thermophilic digestion system 102 and mesophilic digestion system 104, thereby enhancing the energy efficiency of System 100.

The system 100 provides numerous advantages over conventional waste management solutions which may include a significant reduction of greenhouse gas emissions through the capture and utilization of biogas. The system 100 may also facilitate elimination of pathogens and harmful contaminants from organic waste streams. The system 100 may also produce renewable energy in the form of biogas, electricity, and heat. The system 100 may facilitate generation of high-value byproducts, including bio-oil, fertilizers, and soil amendments. The system provides scalability for individual farms and centralized processing facilities. By integrating the thermophilic digestion system 102, the mesophilic digestion system 104, and the bioreactor 106, the system 100 offers a comprehensive solution for sustainable waste management and energy recovery.

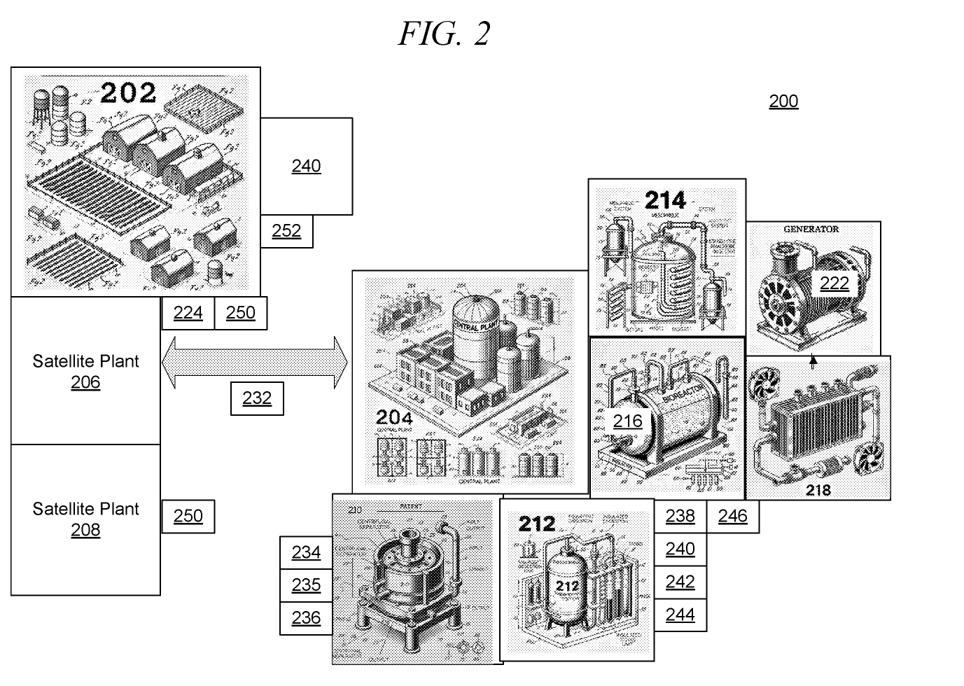

FIG. 2 is a pictorial representation of a system 200 for waste management and resource recovery in accordance with an illustrative embodiment. The system 200 may include a farm 202, a central plant 204, satellite plants 206, 208, and interconnected components for processing organic waste, converting it into renewable energy, and generating high-value byproducts. All or portions of the system 200 may be interconnected utilizing a transport system (e.g., pipes, rail, trucks, drones, etc.) or other interconnecting components. The system 200 and the central plant 204 may include several functional subsystems, including a centrifugal separator 210, thermophilic system 212, mesophilic system 214, bioreactor 216, and off-radiator system 218. Each component plays a critical role in achieving the system's objectives of sustainability, efficiency, and environmental compliance.

The farm 202 is the initial source of organic waste, including manure, carcasses, and other agricultural byproducts. The farm 202 serves as the input location for raw materials, which are transported to the central plant 204 and satellite plants 206, 208 for further processing. Wastewater and raw sewage 232 generated at the farm 202 are collected and transferred to the central plant via pipelines, trucks, rail systems, vacuum trucks, or other transportation systems. In one embodiment, the farm 202 may also be the location of the central plant 204 or the satellite plants 206, 208.

The central plant 204 is the primary processing facility where waste materials are converted into usable resources. The central plant 204 may integrate several systems and/or subsystems. In one embodiment, the central plant 204 may include the centrifugal separator 210.

The sewage 232 may be stored in a lagoon, holding tanks, and/or barn sewage pipes before being moved to the centrifugal separator 210. The centrifugal separator 210 processes raw sewage 232 delivered from the farm 202. The centrifugal separator 210 separates liquids 234 and solids 236 through high-speed centrifugal action. The liquids 234 contains dissolved nutrients, including phosphorus, which is further recovered for use as fertilizers 235. The solids 236 may be transferred to downstream systems for additional processing.

The thermophilic system 212 processes waste materials that require high pathogen reduction and rapid digestion. In one embodiment, the thermophilic system 212 may operate at elevated temperatures (50–60°C), the thermophilic system 212 produces biogas 238 while eliminating harmful pathogens. Heat 240 from the thermophilic system 212 is recovered and distributed via the off-radiator system 218. The thermophilic system 212 processes the liquids 234 to generate methane gas 242. The methane gas 242 may pass through any number of filters and cleaners. The methane gas 242 may be stored or utilized by a generator 222. The generator 222 may burn the methane gas 242 and other applicable gasses to generate electricity 244 that may be returned to the power/electric grid or utilized by the system 200.

The bioreactor 216 is configured to utilize the solids 236 from the centrifugal separator 210 and other subsystems. The bioreactor 216 processes organic solids 236 into bio-oil 246 using thermal and chemical reactions. The bio-oil 246 is a valuable product used in industrial applications such as asphalt binders and specialty coatings.

The off-radiator system 218 manages the heat 240 generated by the thermophilic system 212 and the mesophilic system 214. The off-radiator system 218 includes heat exchangers, fans, and coolant circulation mechanisms to distribute recovered heat 240 back to the system 200. The recovered heat 240 is used to maintain the optimal operating temperatures of the anaerobic digesters, thereby improving energy efficiency.

The mesophilic system 214 processes materials requiring long-term digestion for consistent methane production. The mesophilic system 214 may typically operate at moderate temperatures (30–40°C). The system generates biogas and nutrient-rich digestate for downstream applications.

The satellite plants 206, 208 are auxiliary facilities designed to handle organic waste 250 generated at remote locations. The satellite plants 206, 208 operate as smaller-scale digestion systems that pre-treat or partially process organic waste 250 (e.g., sewage 232, carcasses, food/feed scraps, crop byproducts, etc.) before transferring waste to the central plant 204 for final treatment. The satellite plants 206, 208 plants help reduce transportation costs and extend the system’s reach to multiple farms including the farm 202 within a 1-100 mile radius.

Animal carcasses 252 generated at the farm 202 are transported directly to the mesophilic system 214 for processing by the transport system 224. The transport system 224 ensures biosecurity by using sealed and refrigerated vehicles, trailers, cars, pipes or covered conveyor systems.

The sewage 232 may be transferred from the farm 202 to the central plant 204 for processing in the centrifugal separator 210. Transportation may be facilitated via pipelines, rail cars, or vacuum trucks, ensuring minimal environmental impact.

The integrated operation of the system 200 of FIG. 2 ensures efficient waste management and resource recovery. As noted, the system 200 may generate biogas 238, bio-oil 246, fertilizers 235 (i.e., phosphorous) to reduce greenhouse gas emissions, eliminate pathogens, and reduce the need for traditional waste disposal methods. The biogas 238 captured from the thermophilic system 212 and mesophilic system 214 may be purified, and used for electricity generation or sold to energy markets. The bio-oil 246 produced in the bioreactor may be utilized as a renewable fuel, transportation fuel, blended fuel, and other industrial applications. Bio-oil 246 may be used as a renewable fuel for boilers, furnaces, or turbines. The bio-oil 246 may also be utilized to produce biodiesel for vehicles, ships, agricultural machinery, and other systems and devices. Bio-oil may also be mixed with petroleum-based fuels to reduce carbon emissions and improve fuel sustainability. The fertilizers 235 may be recovered from the liquids 234 of the centrifugal separator 210 for agricultural use.

The system 200 illustrated in FIG. 2 provides numerous advantages including scalability, economic viability, and environmental sustainability. The system 200 may be deployed at farms of various sizes. Valuable byproducts and renewable energy may be produced from materials and resources that were previously disposed of in landfills or other hazardous sites. The system 200 reduces greenhouse gas emissions, prevents groundwater contamination, and supports the circular economy by converting waste into resources.

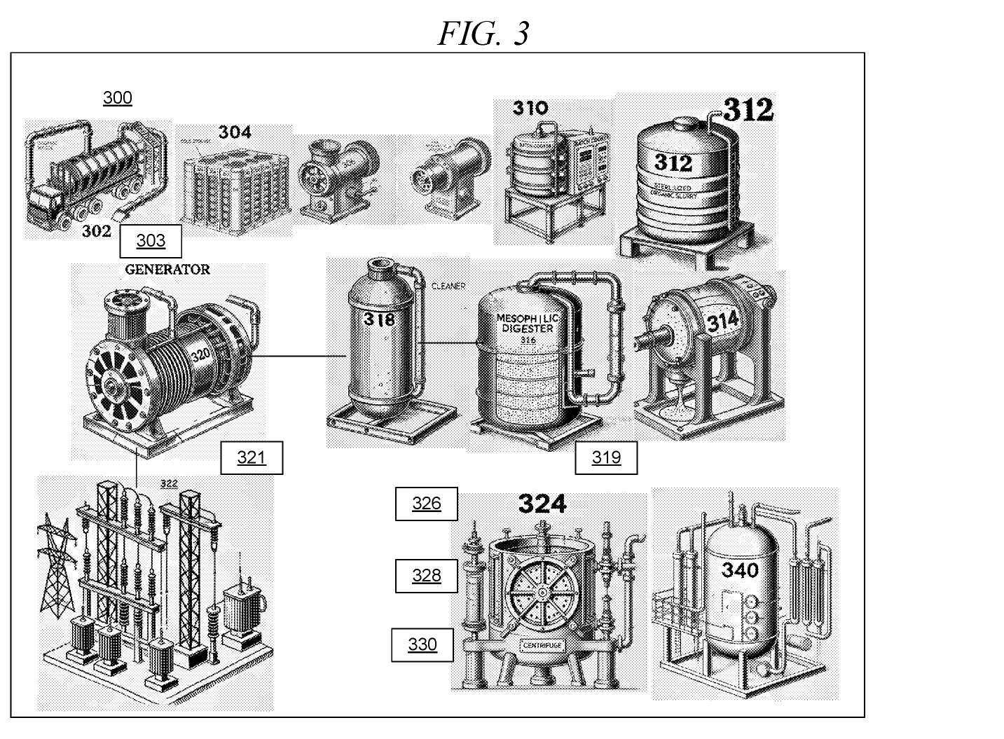

FIG. 3 is a pictorial representation of a system 300 for processing organic waste and converting the waste into renewable energy and valuable byproducts in accordance with an illustrative embodiment. The system 300 may show portions of the mesophilic systems herein described. In one embodiment, the system for 300 may include various systems, components, machinery, and subsystems that facilitate the transport, preprocessing, digestion, separation, and conversion of organic materials into usable resources. The system 300 may include various subsystems that communicate sewage, carcasses, ground mixes, effluents, liquids, and so forth.

The system 300 may include a transportation system 302, cold storage 304, grinders 306, 308, a batch cooker 310, effluent storage 312, a mixer 314, a mesophilic digester 316, a cleaner 318, a methane output 319, a generator 320, an electric grid 322, a centrifuge 324, phosphorus 326, fertilizer liquid 328, solids 330, and a thermophilic system 340. The system 300 operates in a continuous flow, ensuring efficient energy production and resource recovery.

In one embodiment, the system 300 includes a transportation system 302. The transportation system 302 includes a series of vehicles/trailers/cars, pipelines, rails, conveyors, or other mechanism for moving organic waste 303 materials, including animal carcasses and agricultural byproducts, from various collection points to processing locations within system 300. The transportation system 302 ensures the efficient transfer of waste 303 (e.g., organic materials) to the appropriate processing stages while maintaining biosecurity and preventing contamination. Collected waste materials are loaded into the transportation system 302, which conveys the waste to cold storage 304 or directly to grinders 306, 308, depending on processing requirements.

The cold storage 304 is a temperature-controlled chamber or facility where organic waste 303 materials are temporarily stored before further processing. The cold storage 304 may include a refrigerated unit, tanks, dry storage area, tubing lagoons, or so forth. The cold storage 304 prevents premature decomposition and microbial growth, preserving the integrity of raw materials.

The waste delivered via transportation system 302 is deposited into cold storage 304, where it remains at controlled temperatures until needed for further processing. This step is critical for ensuring high-quality biogas and nutrient recovery downstream.

The grinders 306, 308 are mechanical processing units that reduce the size of organic waste materials, increasing their surface area for enhanced breakdown in subsequent processing stages. For example, the grinder 306 may be a large scale grinder or crusher that grins the materials into larger pieces. The grinder 308 may be a fine grinder for grinding the materials directly or from the grinder 306 into much smaller pieces or particulates. The grinding process improves the efficiency of thermal and microbial digestion by ensuring uniform particle size. In one embodiment, the organic waste retrieved from cold storage 304 is fed into grinder 306 for an initial reduction in size. The partially processed material may then be passed to grinder 308 for further refinement, ensuring optimal consistency before moving to batch cooker 310.

The batch cooker 310 is a high-temperature processing unit designed to inactivate pathogens and prepare organic waste for anaerobic digestion. The batch cooker 310 may use controlled heat and pressure to sterilize organic materials before they enter the digestion phase. The ground organic waste from the grinders 306, 308 is transferred to the batch cooker 310.

The batch cooker 310 applies heat at controlled temperatures and pressures to eliminate bacteria, viruses, and other contaminants. For example, hydrogen sulfide H₂S and moisture may be removed. The sterilized material is discharged into effluent storage 312 for further processing.

The effluent storage 312 is a holding tank or storage area where sterilized organic slurry is temporarily stored before mixing and digestion. The effluent storage 312 ensures a continuous and regulated supply of organic material to mixer 314 and prevents system overload. In one embodiment, the sterilized organic material from the batch cooker 310 is directed into the effluent storage 312. The material remains in effluent storage 312 until it is pumped into mixer 314 at controlled intervals.

The mixer 314 is a mechanical unit that homogenizes the organic slurry, creating a uniform mixture suitable for anaerobic digestion. The mixing process optimizes microbial activity during digestion by ensuring uniform nutrient distribution. In one embodiment, the effluent om effluent storage 312 is transferred into mixer 314. The mixer agitates the slurry, breaking down large particles and distributing nutrients evenly. The homogenized slurry is fed into mesophilic digester 316.

The mesophilic digester 316 is an anaerobic digestion unit operating at moderate temperatures (30°C to 40°C) to break down organic waste and produce biogas. This mesophilic digester 316 facilitates microbial decomposition of organic material, generating methane 319 as a byproduct. The mixed organic slurry is introduced into mesophilic digester 316. The microbial activity converts organic matter into methane 319 and digestate. The biogas is extracted, while the remaining liquid and solid byproducts move to centrifuge 324 for separation.

The cleaner 318 is a gas purification unit designed to remove impurities from biogas before its utilization. The cleaner 318 removes contaminants such as hydrogen sulfide and moisture, ensuring a high-purity methane output. The raw methane 319 from mesophilic digester 316 enters cleaner 318. The cleaner 318 filters impurities leaving purified methane 321.

The cleaned methane 321 is directed to generator 320 for energy conversion. The generator 320 is a combustion engine or turbine that converts the cleaned methane 321 into electricity, which is supplied to electric grid 322. The generator 320 provides renewable energy by utilizing cleaned methane 321 produced in the digestion process. The cleaned methane 321 is combusted, expended, or utilized in generator 320 to produce electricity. The generator 320 may also represent a fuel cell or other combustion mechanisms. The generated electricity is fed into electric grid 322.

The centrifuge 324 is a mechanical separator that divides the digested effluent into solid and liquid fractions. The centrifuge 324 enables resource recovery by extracting phosphorus 326, fertilizer liquid 328, and solids 330. In one embodiment, digestate from the mesophilic digester 316 is introduced into centrifuge 324. The centrifuge 324 spins at high speeds to separate components based on density. The outputs of the centrifuge 324 is extracted may include: phosphorus 326 is extracted for fertilizer production, fertilizer liquid 328 stored for agricultural application, and solids 330 that may be further processed as compost or fertilizers.

The thermophilic system 340 is an additional digestion unit that operates at high temperatures (50°C to 60°C) to further process organic solids and maximize gas yield. The thermophilic system 340 enhances biogas production and further reduces waste volume. In one embodiment, solids 330 from the centrifuge 324 are directed into the thermophilic system 340. Thermophilic bacteria continue breaking down organic matter, releasing additional biogas. The remaining material is stabilized and may be used as bio-based industrial feedstock.

The system 300 integrates advanced anaerobic digestion and resource recovery processes, offering: optimized energy production via biogas combustion and electricity generation; efficient nutrient recovery for agricultural applications; and Minimal waste disposal requirements, promoting environmental sustainability. This system 300 provides a scalable and sustainable solution for managing organic waste while maximizing economic value.

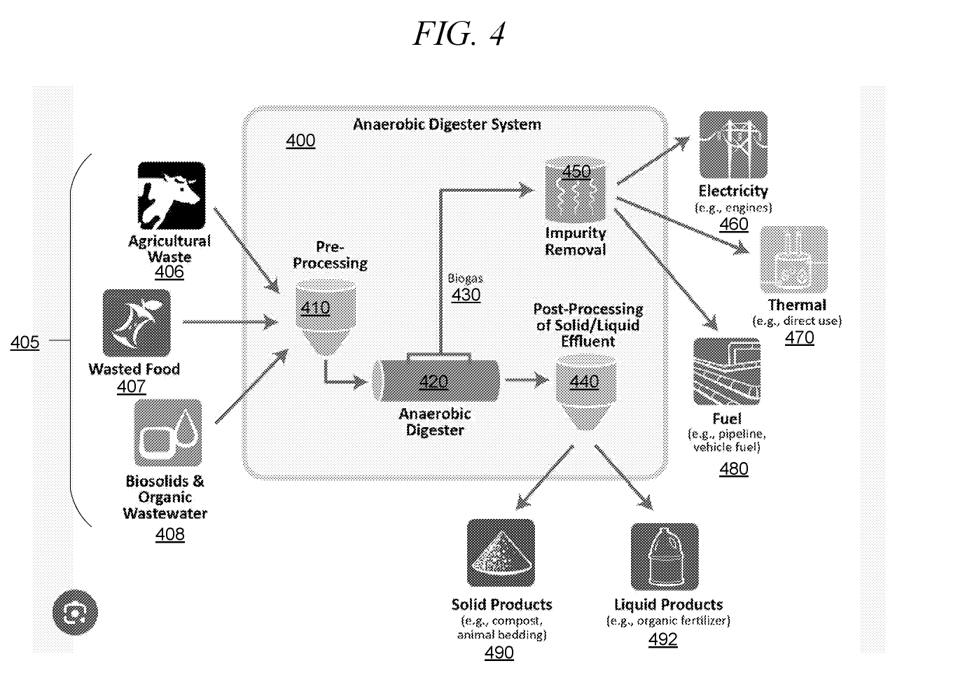

FIG. 4 is a pictorial representation of an anaerobic digester system in accordance with an illustrative embodiment. FIG. 4 depicts the flow and transformation of organic waste 405 into renewable energy and valuable byproducts. A system 400 receives input materials (organic waste 405) including agricultural waste (e.g., manure) 406, wasted food 407, and biosolids & organic wastewater 408, which are collected and directed to a pre-processing stage 410. In the pre-processing stage 410, the input materials undergo sorting, crushing, shredding, grinding, or mixing to prepare them for anaerobic digestion, as indicated by the flow arrows connecting to the anaerobic digester 420.

In one embodiment, the anaerobic digester 420, a sealed cylindrical tank, facilitates the breakdown of organic matter by microorganisms in the absence of oxygen, producing biogas 430 and solid/liquid effluent 440. The biogas 430, a mixture of methane and carbon dioxide, is channeled to an impurity removal stage 450, where it is purified to remove contaminants, resulting in a high-quality biogas output. This biogas 430 is then distributed for multiple applications, including electricity generation 460 (e.g., powering engines), thermal energy production 470 (e.g., direct heating), and fuel production 480 (e.g., for pipelines or vehicle fuel), as shown by the directional arrows extending from the impurity removal stage 450.

The solid/liquid effluent 440 from the anaerobic digester 420 undergoes post-processing, separating it into solid products 490 and liquid products 492. The solid products 490 may include compost or animal bedding while the liquid products 492 may include organic fertilizer. These byproducts are illustrated as outputs of the system 400, providing additional value through agricultural and industrial applications. FIGS. 4-8 use boxes, icons, and arrows to clearly delineate one possible example of the flow of materials and energy, ensuring a comprehensive representation of the system’s operation and functionality, including the efficient management of organic waste, energy generation, and byproduct production.

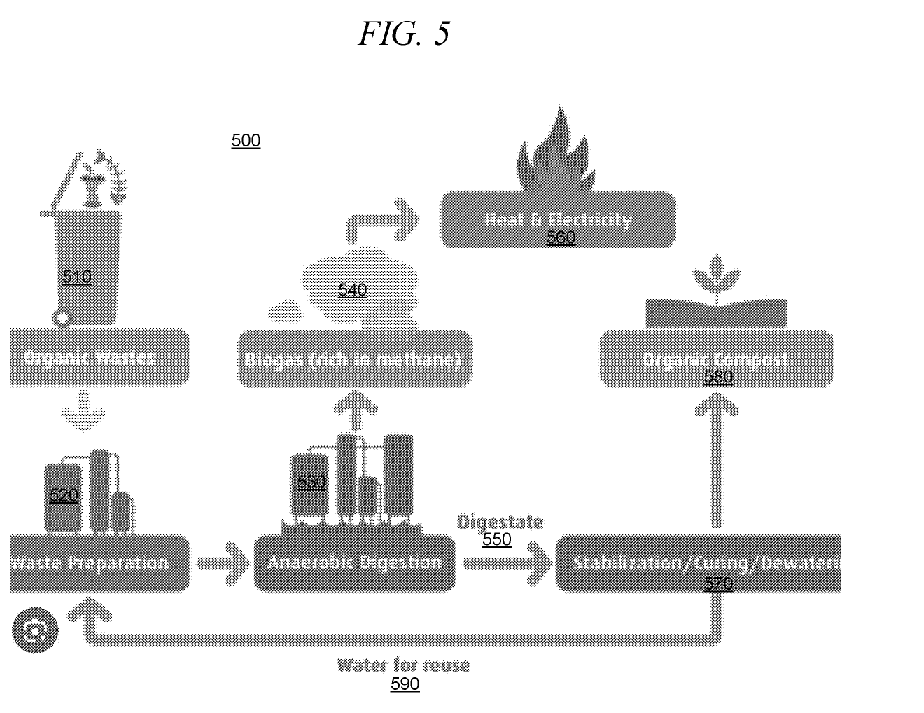

FIG. 5 is a pictorial representation of an anaerobic digestion system in accordance with an illustrative embodiment. FIG. 5 depicts the process of converting organic wastes into renewable energy and organic byproducts. The system 500 begins with organic wastes 510 which may include waste including carcasses, manure, food waste, crop waste, and other biodegradable materials, which are collected and directed to a waste preparation stage 520. In the waste preparation stage 520, the organic wastes undergo sorting, shredding, or other preconditioning processes to optimize their suitability for anaerobic digestion, as indicated by the downward arrow leading to the anaerobic digestion stage 530.

The anaerobic digestion stage 530, depicted as a series of vertical cylindrical tanks, facilitates the breakdown of organic matter by microorganisms in the absence of oxygen, producing biogas 540 (rich in methane) and digestate 550. The biogas 540, illustrated as a cloud-like emission, is channeled upward and converted into heat and electricity 560 providing a renewable energy source for various applications. The digestate 550, a semi-solid or liquid residual material, flows to a stabilization, curing, and dewatering stage 570, where it is processed to produce organic compost 580, depicted as a seedling growing in soil, suitable for agricultural use.

Additionally, the system 500 includes a water reuse cycle 590, shown as a downward arrow looping back from the stabilization stage 570, indicating that water extracted during the dewatering process is treated and recycled for reuse within the system.

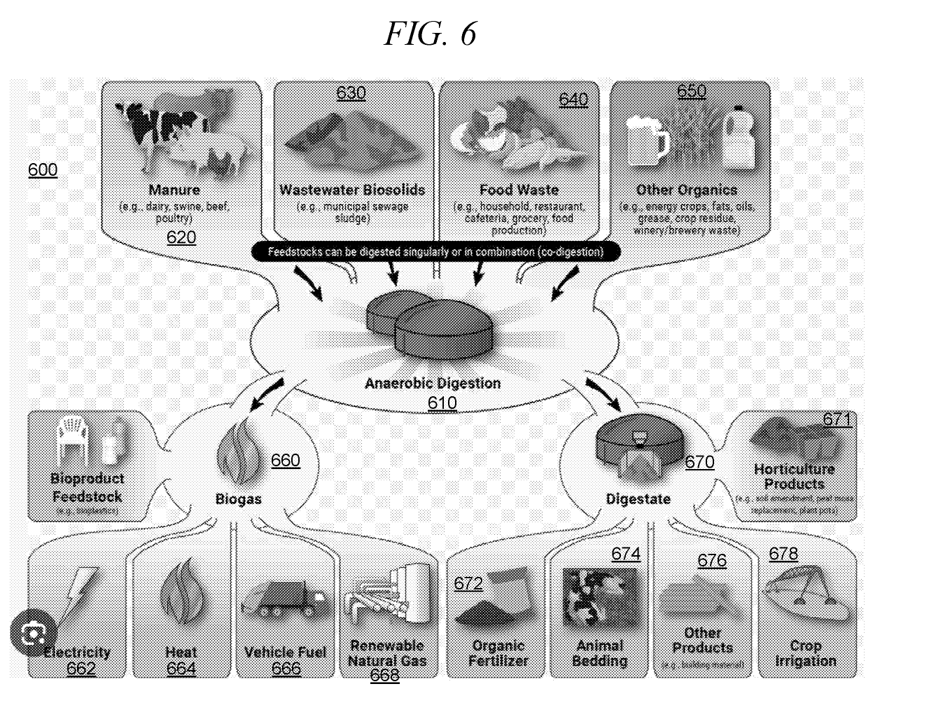

FIG. 6 is a pictorial representation of an anaerobic digestion system in accordance with an illustrative embodiment. FIG. 6 shows the processing of various feedstocks into renewable energy and diverse bioproducts. A system 600 receives multiple types of feedstocks, which can be digested singularly or in combination (co-digestion), as indicated by the central hub labeled “Anaerobic Digestion” 610. The feedstocks include manure 620 (e.g., dairy, swine, beef, poultry), wastewater biosolids 630 (e.g., municipal sewage sludge), food waste 640 (e.g., household, restaurant, grocery, cafeteria production), and other organics 650 (e.g., grease, energy crops, fats, oils, crop residue, winery/brewery waste) feeding the anaerobic digestion 610.

Within the anaerobic digestion stage 610 tanks, the feedstocks undergo microbial breakdown in the absence of oxygen, producing two primary outputs: biogas 660 and digestate 670. The biogas 660 is further processed and utilized for multiple energy applications, including electricity generation 662 (e.g., powering systems), heat production 664 (e.g., for heating), vehicle fuel 666 (e.g., for transportation), and renewable natural gas 668 (e.g., for pipeline integration). The digestate 670 is further processed and utilized to generate multiple products, such as horticulture products 671 (e.g., soil peat moss, organic pots, etc.), organic fertilizer 672, animal bedding 674, other products 676 (e.g., building materials), and crop irrigation 678.

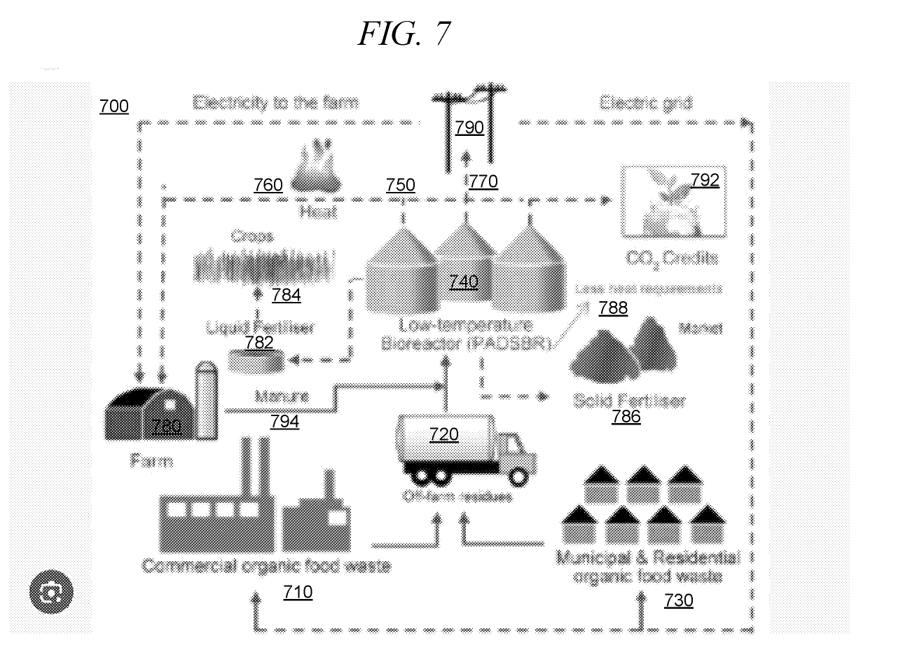

FIG. 7 is a pictorial representation of a psychrophilic anaerobic digestion system in accordance with an illustrative embodiment. A system 700 of FIG. 7 may be utilized for processing semi-dry mixed municipal food waste into renewable energy, fertilizers, and providing environmental benefits. The system 700 receives input materials from multiple sources, including commercial organic food waste 710 (e.g., from industrial food production), off-farm residues 720 (e.g., agricultural byproducts), and municipal & residential organic food waste 730 (e.g., household and community food scraps). These inputs (710, 720, 730) are directed to a low-temperature bioreactor (PADSBR) 740, depicted as a series of conical silos, where psychrophilic (low-temperature) anaerobic digestion occurs with less heat requirements.

Within the low-temperature bioreactor 740, the organic waste is broken down by microorganisms at reduced temperatures, producing biogas 750, which is converted into heat 760 and electricity 770, distributed to the farm 780 (e.g., for powering farm operations) and the electric grid 790 (e.g., for broader energy supply). The digestate from the bioreactor 740 is processed into two types of fertilizers: liquid fertilizer 782, directed to crops 784 on the farm (e.g., for agricultural use), and solid fertilizer 786, marketed for external use 788. The system 700 also generates CO₂ credits 792, represented by a green leaf icon, contributing to environmental sustainability.

Manure 794 from the farm 780 is integrated into the system 700 as an additional input, enhancing the digestion process. The system 700 is efficient at low-temperature processing, energy generation, fertilizer production, and generating carbon credit benefits.

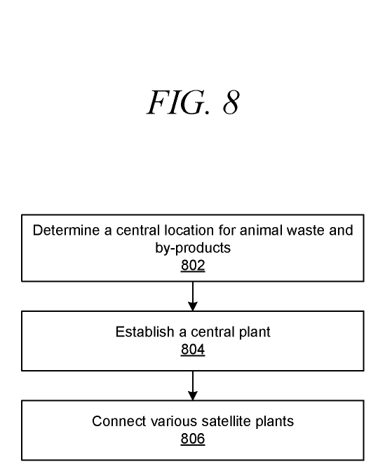

FIG. 8 is a pictorial representation of a flowchart for a waste management and bioproduct recovery system. All or portions of the processes described in FIGS. 1-13 may be implemented manually or automatically. In addition, the various steps may be performed by the systems, facilities, and platforms described in FIGS. 1-7. The process may include determining a central location for animal waste and by-products, establishing a central plant, and connecting satellite plants to form an integrated and scalable network for sustainable waste processing and energy generation.

The process may begin by determining a central location for processing animal waste and by-products (step 802). In this step, the system identifies an optimal site based on logistical and operational considerations, such as proximity to waste sources. The location may be selected to ensure it is near high-density livestock operations or swine farms to minimize transportation distances and costs. In many cases, high-density livestock and farm operations are often located proximate each other because of zoning, coordination, optimized land usage, or happenstance. Location may also be selected based on accessibility and infrastructure. For example, transportation networks (e.g., roads) and access to utilities such as water and electricity are critical for operational efficiency. The location may also be selected based on environmental considerations. The site must comply with environmental regulations, ensuring minimal risk of groundwater contamination and reduced impact on surrounding ecosystems. The location may also be selected based on land availability. Sufficient land is required to accommodate the infrastructure for the central processing facility, storage systems, and future expansion. The selected central location serves as the primary hub for receiving, processing, and redistributing waste materials and their derivatives.

Next, the system establishes a central plant (step 804). Once the central location is determined, a central processing plant is established. This central plant is designed to handle large-scale processing of organic waste, including swine manure and carcasses, converting these materials into renewable energy and valuable by-products. The central plant may include all or portions of the system 100 of FIG. 1 following waste processing units, and preprocessing equipment, thermophilic and mesophilic digesters, energy generation systems, biogas collection and purification systems, combined heat and power (CHP) systems/units, by-product recovery systems, bioreactors, liquid fertilizer systems, and water recycling systems. The central plant may utilize advanced emission control systems to mitigate greenhouse gas emissions and ensure compliance with environmental standards as well as recover and reuse water. The central plant may operate as a hub, integrating waste processing, energy generation, and by-product recovery into a cohesive and efficient system.

Next, the system connects various satellite plants (step 806). To maximize efficiency and scalability, satellite plants are deployed at or near individual farms and connected to the central plant. The satellite plants serve as decentralized preprocessing and digestion units, reducing the need for long-distance transportation of raw waste. Each satellite plant may be equipped with modular thermophilic or mesophilic digesters tailored to handle the daily waste output of a specific farm, and preprocessing equipment to separate solid and liquid fractions from the waste, ensuring compatibility with the central plant's processing systems, and communications and monitoring systems for remote management of satellite plant operations to ensure safe and consistent performance. The satellite plants may be integrated with the central plant utilizing pipes, rail systems, autonomous transport vehicles, manual vehicle systems, and so forth.

Solid fractions from satellite plants may be transported to the central plant for further processing into bio-oil or other high-value by-products. The biogas generated at satellite plants may be stored and transported to the central plant or utilized locally for electricity and heat production.

There are numerous benefits to the central plant integrated with or connected with satellite plants. Localized waste processing reduces logistics costs and minimizes the environmental impact associated with raw waste transportation. Renewable energy generated at satellite plants provides farms with sustainable electricity and heating solutions. By forming a network between the central plant and satellite plants, the system ensures efficient waste collection and resource utilization across all connected farms.

The process illustrated in FIG. 8 provides several key advantages by significantly reducing greenhouse gas emissions by capturing methane and converting it into renewable energy. The system and process eliminates pathogens from waste streams and prevents contamination of land and water resources. The system and process also provides economical viability by generating high-value by-products, including bio-oil, fertilizers, and renewable energy, creating new revenue streams for farmers and operators. The modular design of satellite plants allows the system to scale according to the size and needs of individual farms, while the central plant ensures large-scale processing and value recovery. The integration of thermophilic and mesophilic digestion systems with advanced bioreactors maximizes the conversion of organic waste into usable resources, minimizing waste disposal requirements. In summary, the process outlined in FIG. 8 demonstrates a novel and efficient approach to managing agricultural waste, enabling sustainable energy production and resource recovery while addressing key environmental and economic challenges.

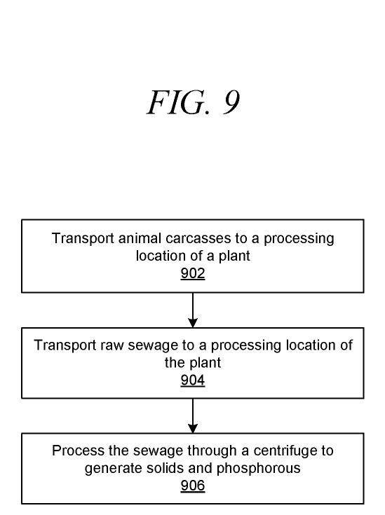

FIG. 9 is a flowchart of a process for processing organic wastes in accordance with an illustrative embodiment. FIG. 9 illustrates a method for transporting and processing organic waste materials, including animal carcasses and raw sewage, to generate valuable outputs such as solids and phosphorus. The process involves the transportation and controlled processing of these materials within a specialized plant facility (see the Figures including FIG. 1) to optimize resource recovery and reduce environmental impact. The process may include transporting animal carcasses (step 902), transporting raw sewage (step 904), and processing the raw sewage through a centrifuge (step 906).

The process may begin by transporting animal carcasses to a processing location of a plant (step 902). The transportation of carcasses may involve refrigerated or sealed vehicles to ensure biosecurity, prevent odor emissions, and limit the spread of pathogens during transit. The transportation logistics may be coordinated to align with plant operational schedules, thereby minimizing the storage duration of carcasses at the facility. Upon arrival at the plant, the animal carcasses are offloaded into designated storage or preprocessing areas. The processing areas may include grinding or chopping units, where the carcasses are reduced to smaller, more manageable pieces for subsequent processing. The processing units may also include cooker units, where the carcasses or other materials undergo a high-temperature treatment to deactivate viruses, bacteria, and other pathogens prior to integration into the anaerobic digestion process. This preprocessing step may ensure that the carcasses are safely and efficiently incorporated into the overall waste management and energy recovery process.

Next, the system transports the raw sewage to a processing location of the plant (step 904). The raw sewage may originate from agricultural operations, including swine manure or wastewater effluent, and is typically collected from on-site or off-site storage lagoons or pits. Transportation may be facilitated through vacuum trucks, railway systems, or pipeline systems, which are designed to handle liquid and semi-solid waste efficiently or holding tanks, which serve as intermediate storage at the plant to ensure a steady and continuous supply of raw sewage for processing. Upon reaching the plant, the raw sewage may be routed to preprocessing modules where any large debris or non-digestible materials are removed. Preprocessing also includes blending the sewage to achieve a uniform consistency suitable for downstream treatment.

Next, the system processes the sewage through a centrifuge to generate solids and phosphorous (step 906). The preprocessed sewage and carcasses may be fed into a centrifuge for separation into its constituent components. The centrifuge is a critical component of the plant’s waste processing system, designed to efficiently separate liquid and solid fractions while recovering valuable nutrients such as phosphorus.

The operation of the centrifuge may preprocess the sewage. For example, the preprocessed sewage is pumped into the centrifuge using high-capacity feed pumps that ensure consistent flow rates and minimize process interruptions. The centrifuge may spin the sewage at high speeds, creating a centrifugal force that separates the heavier solid particles from the liquid fraction. Solids, including organic fiber material, settle to the outer edges of the centrifuge and are collected for further processing or disposal. The liquid fraction contains dissolved phosphorus, which is extracted and concentrated using additional downstream processing units. The recovered phosphorus is then refined into a fertilizer-grade product suitable for agricultural applications.

The solid fraction is directed to further processing units, such as thermophilic or mesophilic anaerobic digesters, for conversion into bio-oil or other marketable byproducts. The liquid fraction is treated to remove any remaining contaminants and may be used as a nutrient-rich liquid fertilizer or recycled within the plant. The steps described in FIG. 9 operate in a coordinated manner to ensure the efficient and environmentally responsible processing of organic waste materials. For example, animal carcasses transported in step 902 may be preprocessed and integrated into the plant’s thermophilic digestion system. Raw sewage transported in step 904 may be blended and processed through the plant’s centralized centrifuge system in step 906. The outputs of step 906, solid fractions and recovered phosphorus, may be utilized as feedstocks for other plant systems or marketed as high-value byproducts. The process depicted in FIG. 9 provides multiple advantages, such as reduction of environmental contamination through pathogen elimination and nutrient recovery, efficient separation and recovery of phosphorus, addressing global concerns regarding phosphorus scarcity, creation of marketable products, such as fertilizers and bio-oil, from waste materials, and integrated handling of diverse waste streams, enabling scalability and adaptability for various agricultural operations.

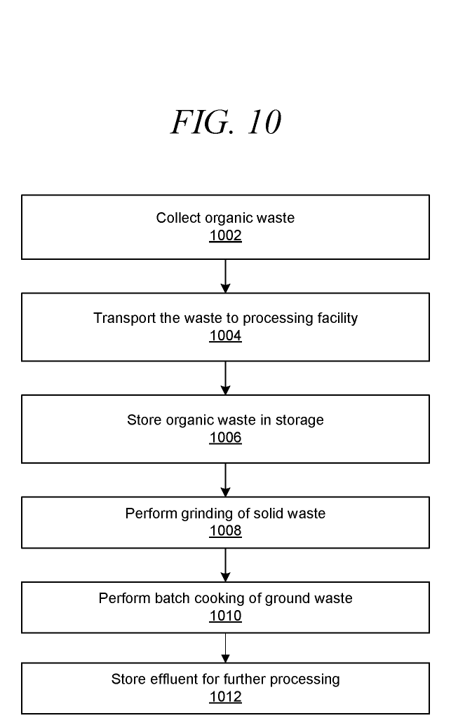

FIG. 10 is a flowchart of a process for transporting and preprocessing waste in accordance with an illustrative embodiment. All or portions of the processes herein described may be performed automatically or semi-automatically.

The process may begin by collecting organic waste (step 1002). The waste may be automatically or manually collected utilizing conveyors, robotics, and so forth. For example, the waste may include animal carcasses, manure, and other agricultural byproducts.

Next, the system transports the waste to a processing facility (step 1004). The waste may be transported or otherwise communicated utilizing pipelines, vacuum trucks conveyor systems, rail systems, or so forth.

Next, the system stores organic waste in storage (step 1006). The storage may include cold storage or regular storage (e.g., holding tanks, lagoons, etc.). The storage may ensure that the waste is stored in desired conditions (e.g., temperature, humidity, pressure, mixing, etc.).

Next, the system performs grinding of solid waste (step 1008). The grinding process may include an initial grinding process to reduce the size of organic materials and a secondary grinding process to generate smaller more uniform particle sizes.

Next, the system performs batch cooking of ground waste (1010). Batch cooking is the thermal treatment of the ground waste. Thermal treatments help eliminate bacteria and other pathogens through controlled heat, pressure, and other parameters.

Next, the system stores effluent for further processing (step 1012). The effluent storage may be a temporary holding tank for the sterilized slurry. The storage may regulate feeding of the effluent into one or more digestion systems.

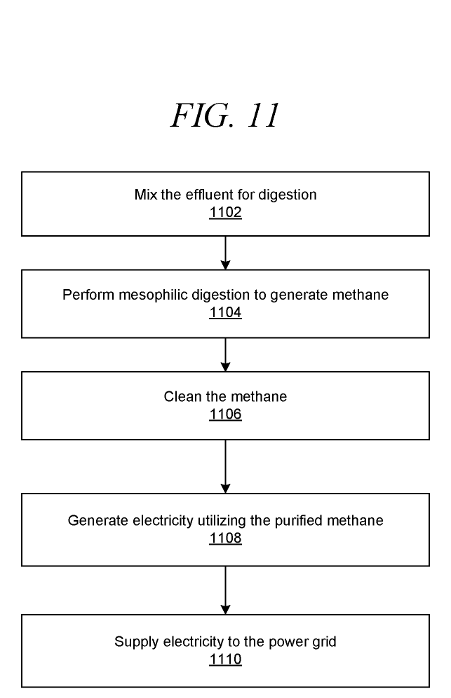

FIG. 11 is a flowchart of a process for anaerobic digestion and energy generation in accordance with an illustrative embodiment. The process of FIG. 11 may begin by mixing the effluent for digestion (step 1102). The mixers homogenize the slurry to optimize nutrient distribution.

Next, the system performs mesophilic digestion to generate methane (step 1104). One or more mesophilic digesters may perform anaerobic digestion at desired temperatures, such as 30-40 Celsius. Step 1104 facilitates breakdown of organic matter and optimizes methane generation.

Next, the system cleans the methane (step 1106). The cleaner purifies the methane gas by removing impurities. As a result, high-quality biogas is generated for energy production.

Next, the system generates electricity utilizing the purified methane (step 1108). The generator converts the purified methane into electricity.

Nex, the system supplies electricity to the power grid (step 1110). The electricity is supplied to one or more power grids.

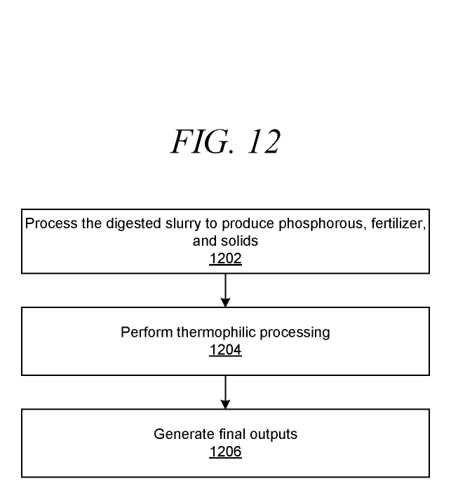

FIG. 12 is a flowchart of a process for resource recovery and byproduct processing in accordance with an illustrative embodiment. The process of FIG. 12 may begin by processing the digested slurry to produce phosphorous, fertilizer, and solids (step 1202). The centrifuge separates the digested slurry into phosphorous, fertilizer liquids, and solids. The phosphorous is utilized for fertilizer product and other implementations, the fertilizer liquid is used as a nutrient-rich liquid for agricultural use, and the solids may be utilized as compost. The phosphorous may be processed to reach 95% purity. In one embodiment, a polymer or flocculant may be added to the centrifuge feed to achieve the requisite level of purity.

Next, the system performs thermophilic processing (step 1204). The thermophilic system processes solids at 50-60 Celius. The thermophilic system may generate additional methane for cleaning and utilization. The thermophilic processing may also reduce the final waste volume.

Next, the system generates final outputs (step 1206). The final outputs may include renewable electricity, fertilizer products (e.g., liquid and phosphorous-rich solids), and stabilized compost.

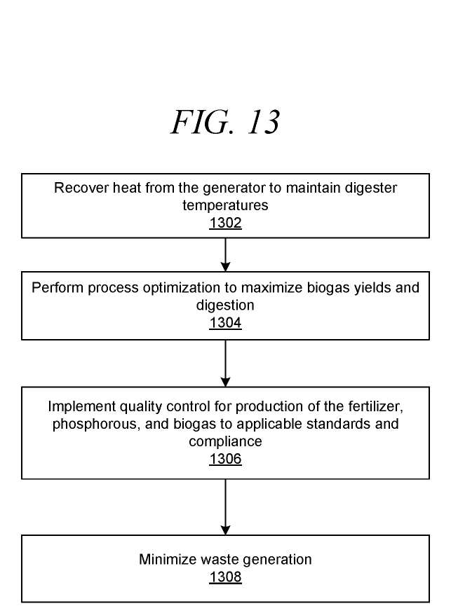

FIG. 13 is a flowchart of a process for system operation and optimization in accordance with an illustrative embodiment. The process of FIG. 13 may begin by recovering heat for the generator to maintain digester temperatures (step 1302). Heat recovery adds additional efficiency to the system.

Next, the system performs process optimization to maximize biogas yields and digestion (step 1304). In one embodiment, feedstock blends may be adjusted based on biogas yields. The real-time parameters, settings, and conditions of the digesters may be monitored and adjusted to maximize desired outputs.

Next, the system implements quality control for production of the fertilizer, phosphorous, and biogas to applicable standards and compliance (step 1306).

Next, the system minimizes waste generation (step 1308). The thermophilic system reduces the final waste volume and amounts. As a result, near-zero waste output levels may be achieved.

The illustrative embodiments provide a system and method for generating renewable green energy using digestion technologies for organic waste including manure (e.g., dairy, swine, beef, poultry, etc.), carcasses, food waste (e.g., animal feed, household, restaurant/cafeteria, grocery, food production, etc.), and other organics (e.g., crops/crop residue, fats, oils, grease, etc.). A central facility is established proximate a number of farms or facilities providing the organic waste, such as swine, poultry, beef, or other animal farms. The central facility may be modularly established to be moved or relocated as circumstances or demand requires.

Some locations within the world have significant issues with excessive organic waste, including, but not limited to untreated manure, excess carcasses, animal and crop byproducts, food waste, and so forth. The illustrative embodiments are implemented to utilize these organic wastes that are often considered a nuisance and available in high levels for the benefit of the famers, environment, society, and nearby communities and households.

The system and method may be established to produce renewable energy, protect air, land, and water resources, produce usable byproducts (e.g., phosphorous, fertilizer, compost, etc.), improve disease control, reduce odors, reduce carbon footprints, lower or eliminate heating and cooling costs for farmers, minimize landfill and disposal resources, and support the farming community (e.g., lowering waste management costs, barriers, concerns, etc.).

The illustrative embodiments utilize anaerobic digestion, mesophilic, and thermophilic digestion to produce usable products and eliminate waste. The central plant or central system is preferably located within ten miles of multiple farms or organic waste sources.

The previous detailed description is of a small number of embodiments for implementing the invention and is not intended to be limiting in scope. The following claims set forth a number of the embodiments of the invention disclosed with greater particularity.

What is claimed:

1. A method for processing organic waste, the method comprising:
a central processing facility;
a plurality of satellite facilities;
transporting the organic waste via a transportation system;
storing at least a portion of the organic waste in one or more cold storages;
grinding the organic waste utilizing grinders to generate ground waste;
thermally treating the ground waste in a batch cooker to generate an effluent;
storing the effluent in an effluent storage;
mixing the slurry in a mixer;
digesting the slurry in a mesophilic digester to produce methane and a digested slurry;
cleaning the methane in a cleaner to produce purified methane;
converting the purified methane into electricity using a generator;
supplying electricity to a power grid;
separating the digested slurry using a centrifuge to yield phosphorus fertilizer liquid, and solids; and
processing the solids in a thermophilic system.

2. The method according to claim 1, wherein the effluent is a sterilized slurry.

3. The method according to claim 1, wherein the grinders include at least a course grinder and a fine grinder.

4. The method according to claim 1, wherein the transportation system includes one or more of a truck and trailer system, rail systems, drone system, and pipes, ditches/canals.

5. The method according to claim 1, wherein the thermophilic digestion reduces volatile solids by at least 70%.

6. The method according to claim 1, wherein the mesophilic digestion occurs over a retention period of 15 to 30 days.

7. The method according to claim 1, wherein the combined mesophilic and thermophilic digestion processes achieve a biogas yield of at least 0.45 cubic meters per kilogram of volatile solids.

8. The method according to claim 1, wherein the generated electricity offsets at least 80% of the processing facility’s energy requirements.

9. The method according to claim 1, wherein the system achieves a total waste volume reduction of at least 90%.

10. A system for processing organic waste, comprising:
a transportation system configured to transport organic waste to a processing facility;
a cold storage unit for preserving the organic waste at controlled temperatures;
one or more grinders for reducing the organic waste to uniform particle sizes;
a batch cooker configured to thermally treat the ground waste to deactivate pathogens;
an effluent storage tank for temporarily holding sterilized slurry;
a mixer for homogenizing the slurry;
a mesophilic digester for anaerobic digestion of the homogenized slurry to produce methane;
a cleaner for purifying the methane gas;
a generator connected to an electric grid for converting the purified methane into electricity;
a centrifuge for separating digested slurry into phosphorus, fertilizer liquid, and solids; and
a thermophilic system for further digesting the solids.

11. The system according of claim 10, wherein the transportation system includes pipelines, vacuum trucks, and conveyor systems for waste transfer.

12. The system of claim 10, wherein the homogenized slurry is processed at a temperature range of 30-40°C, wherein the thermophilic system digests the solids at a temperature range of 50-60°C, and wherein the cold storage unit maintains temperatures between 0°C to 5°C.

13. The system of claim 10, wherein the mesophilic digester comprises microbial communities optimized for methane production.

14. The system of claim 10, wherein the centrifuge separates phosphorus with at least 95% purity.

15. The system of claim 10, further comprising a heat recovery system configured to recycle heat from the generator to maintain optimal digester temperatures.

16. The system of claim 10, wherein the processing facility comprises a central location and at least one satellite location for decentralized waste collection and preprocessing.

17. The system of claim 10, wherein each satellite location includes a modular processing unit configured to preprocess organic waste before transferring it to the central location for final processing.

18. The system of claim 10, wherein the modular processing unit at each satellite location comprises at least one of the following: a cold storage unit, a grinder, an effluent storage tank, or a mesophilic digester.

19. The system of claim 10, wherein the central location houses high-capacity processing components including a batch cooker, a thermophilic system, and a centrifuge for large-scale separation of fertilizer components.

20. The system of claim 10, wherein the modular nature of the system enables scalability by allowing additional digesters, separators, and bio-energy recovery units to be integrated as operational needs increase, wherein additional modules can be connected via a smart control system to optimize biogas production, nutrient recovery, and overall energy efficiency, and wherein the modular processing units at the satellite locations operate independently but are capable of transmitting operational data to the central location for real-time monitoring and control.
